(19) United States
(12) Patent Application Publication
(10) Pub. No.: US 2016/0258659 A1
(43) Pub. Date: Sep. 8, 2016

(54) HYBRID POWER AND COOLING SYSTEM

(71) Applicant: Oregon State University, Corvallis, OR (US)

(72) Inventors: Hailei Wang, Corvallis, OR (US); Thomas Herron, Bend, OR (US)

(73) Assignee: Oregon State University

(21) Appl. No.: 15/059,079

(22) Filed: Mar. 2, 2016

Related U.S. Application Data
(60) Provisional application No. 62/127,707, filed on Mar. 3, 2015.

(51) Int. Cl. F25B 27/02; F25B 13/00; H05B 3/00; F25B 41/04; F25B 25/00; F25B 11/02; F25B 31/00

(52) U.S. Cl. CPC F25B 27/02; F25B 11/02; F25B 13/00; F25B 31/00; F25B 41/046; F25B 25/005; H05B 3/0014

(57) ABSTRACT

A hybrid power and cooling system includes a cooling system that absorbs and removes heat from a space and includes a compressor for compressing a circulating refrigerant and a waste heat recovery system with an expander configured to use a working fluid to generate mechanical work by expansion using heat received from a heat source. The waste heat recovery system can be coupled to the compressor of the cooling system to drive the compressor by the generated mechanical work. The condensing heat of the fluid in the waste heat recovery system can be used to providing heating function.

### CROSS-REFERENCE TO RELATED APPLICATION

This application claims the benefit of U.S. Provisional Application No. 62/127,707, which was filed on Mar. 3, 2015, and is incorporated herein by reference in its entirety.

### FIELD

The present disclosure is directed to hybrid power and cooling systems and applications thereof.

### BACKGROUND

Various applications use energy generated from combustion engines to provide heating and cooling. For example, modular Environmental Control Units (ECUs or IECUs) are frequently used to heat and cool military troop shelters and other enclosures in varying ambient conditions, including some very extreme conditions. These ECUs are generally powered by diesel generators. However, these diesel generators, or gensets, like all combustion engines, can be inefficient. As a result, the fuel costs for operating these systems can be high and improvements to such systems that can improve efficiencies and/or reduce fuel consumption are desirable.

### SUMMARY

In one embodiment, a hybrid power and cooling system is provided. The system can include a cooling system that absorbs and removes heat from a space and an expander coupled to a heat source. The cooling system comprises a compressor for compressing a circulating refrigerant and the expander is configured to use a working fluid to generate mechanical work by expansion. The expander can be within an organic Rankine cycle and the cooling system can be a vapor compression cycle. The expander is coupled to the compressor of the cooling system to drive the compressor by the generated mechanical work and a motor/generator is coupled to the compressor of the cooling system to drive the compressor. The motor/generator can be coupled to the expander and can receive mechanical work generated by the expander and convert it to electrical energy.

In some embodiments, the system can include one or more clutch members that allow disengagement of the motor/generator from the system, and/or independent engagement of any of the cooling system, expander, and motor/generator from the system.

In another embodiment, the system includes a cooling system that is a vapor compression cycle having a shaft-driven compressor and an expander that is within an organic Rankine cycle, with the expander coupled to one or more waste heat sources for generating power to drive the shaft-driven compressor. A motor/generator is coupled to the cooling system to drive the shaft-driven compressor when the power generated by the expander in insufficient. The motor/generator can also be coupled to the expander to convert power generated by the expander into electrical energy. The motor/generator and cooling system can collectively comprise an environmental control unit (ECU). If desired, one or more clutch members can allow the expander and motor/generator to engage the shaft-driven compressor separately or collectively.

In another embodiment, a method of recovering waste heat to drive a hybrid power and cooling system is provided. The method includes directing waste heat to an organic Rankine cycle (ORC) or similar power cycle, with an expander that is configured to use a working fluid to generate power by expansion, and driving a compressor of a cooling system that is configured to absorb and remove heat from a space using the power generated by the expander. Power generated by the expander can be supplemented with mechanical work produced by a motor/generator coupled to the compressor of the cooling system to drive the compressor. In some embodiments, the motor/generator can be disengaged from the system (such as when the power generated by the expander is sufficient to meet a current cooling demand). The motor/generator can also be used to convert power generated by the expander into electrical energy when no cooling is needed or the power generated by the expander exceeds that needed to meet a current cooling demand. The waste heat source can include heat generated by a genset and/or waste heat generated by other sources, such as solar or geothermal sources.

### BRIEF DESCRIPTION OF THE DRAWINGS

FIG. 1 is a schematic illustration of a hybrid system for incorporating waste heat recovery to an expander/compressor system.

FIG. 2 is another a schematic illustration of a hybrid system for incorporating waste heat recovery to an expander/compressor system.

FIG. 3 is another a schematic illustration of a hybrid system for incorporating waste heat recovery to an expander/compressor system.

FIG. 4 is another schematic illustration of a hybrid system for incorporating waste heat recovery to an expander/compressor system, with a motor/generator that can be engaged and disengaged from a drivetrain of the system.

FIG. 5 is another schematic illustration of a hybrid system for incorporating waste heat recovery to an expander/compressor system, with a motor/generator that can be engaged and disengaged from a drivetrain of the system.

FIG. 6 is another schematic illustration of a hybrid system for incorporating waste heat recovery to an expander/compressor system, with a motor/generator that can be engaged and disengaged from a drivetrain of the system.

FIG. 7 is another a schematic illustration of a hybrid system for incorporating waste heat recovery to an expander/compressor system.

FIG. 8 is a chart indicated exemplary dimensions of microchannel boiler and recuperator systems.

FIG. 9A is a chart comparing exemplary boiler effectiveness for microchannel heat exchangers and plate heat exchangers.

FIG. 9B is a chart comparing exemplary recuperator effectiveness for microchannel heat exchangers and plate heat exchangers.

FIG. 10 is a chart indicating exemplary rest results of a hybrid system for incorporating waste heat recovery to an expander/compressor system operating on three different days.

FIG. 11 illustrates an exemplary drive component details of a system using three electromagnetic clutches and various pulleys.

FIG. 12 illustrates an ORC power cycle with a waste heater, which is a secondary condenser.

FIG. 13A illustrates a rectangular waste heater assembly inside the evaporator section with arrows showing air flow paths.

FIG. 13B illustrates the waste heater assembly of FIG. 13A with four panel sections (A, B, C, and D).

FIG. 14 shows a table of exemplary dimensions for the sections of heating panels shown in FIG. 13B.

FIG. 15 illustrates a flexible cooling, heating and power system without and without a waste heater condenser and optional electrical resistance heating elements.

### DETAILED DESCRIPTION

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “determine” and “provide” to describe the disclosed methods. These terms are high-level abstractions of the actual operations that are performed. The actual operations that correspond to these terms may vary depending on the particular implementation and are readily discernible by one of ordinary skill in the art.

The systems and methods disclosed herein use novel heat activated cooling technologies to provide systems that operate with higher efficiencies and/or reduced fuel requirements. In one particular application of the disclosed systems, the hybrid power/cooling arrangement can be applied to environmental control units (ECUs or IECUs) for more efficient waste heat recovery and power generation and space cooling. This can allow for recovery and use of waste heat, such as waste heat from a remote power supply that operates without connection to a power grid, using an expander. As used herein, the term “remote power supply” means any system that can operate independently of a power grid (e.g., using gasoline or natural gas), such as a diesel generator. As used herein, an “expander” is a device or system that uses a working fluid to generate work by expansion.

In addition to generating power from the expander to drive an ECU, in some embodiments, motor/generators can be provided to allow for greater operational flexibility. As used herein, a “motor/generator” is a device or system that can function as a motor to generate mechanical power or as a generator to convert mechanical power to electrical energy. As discussed in more detail below, the motor/generators disclosed herein can function as a generator when an expander is making excess power (such as when there is no cooling need) or as a motor to electrically drive the ECU (e.g., a compressor associated with the ECU) when insufficient power is being generated by the expander to meet a cooling demand.

The disclosed technology is based on a dual-cycle concept referred to as expander/compressor heat activated cooling herein. As used herein, a “compressor” is a device or system that absorbs and removes heat from a space to be cooled by compressing a circulating refrigerant. In some embodiments, the expander is in an organic Rankine cycle (ORC) and the compressor is in a vapor compression cycle (VCC). In other embodiments, other combinations of expanders and compressors can be used. For example, instead of an ORC, the power cycle or heat engine cycle (with the expander acting as a shaft power producing device) can be a supercritical CO2 cycle, Kalina cycle, or Stirling cycle in other embodiments.

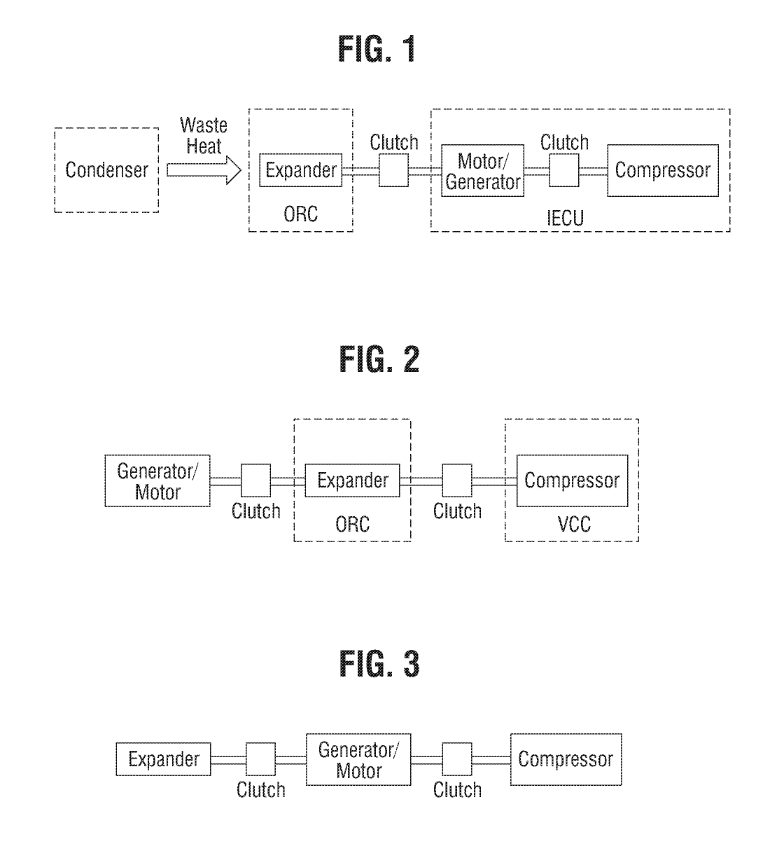

Exemplary configurations of the hybrid power and cooling system are disclosed herein. FIG. 1 illustrates the recovery of waste heat from a genset and provided to an expander (e.g., an ORC). As shown in FIG. 1, waste heat is converted to power in the ORC, which can then be used to drive the cooling cycle. The source of waste heat driving the expander can be any collected heat source sufficient to be used as the heat source for a particular expander system. In some embodiments, for example, the waste heat can be waste heat recovered from a genset (i.e., a diesel generator). In other embodiments, the waste heat can be supplemented or, alternatively, entirely supplied by other sources, such as solar heat sources, geothermal heat sources, or other heat sources.

The system of FIG. 1 includes a drivetrain design with a clutch member coupling the expander (e.g., an ORC) and an ECU, which includes a motor/generator and a compressor (e.g., a VCC) and another clutch member coupling the motor/generator and compressor. The clutch members can be, for example, electromagnetic clutches. This arrangement is discussed in more detail below with respect to FIG. 3.

FIG. 2 illustrates another embodiment where a motor/generator is provided to supplement power input to the expander/compressor cycle. As in FIG. 1, the expander is driven by waste heat (not shown). Gear sets may be provided inside the expander to provide two separate shafts coming out. The clutches can be independently operable, such that, depending on operational requirements, one or both clutches can be engaged at any given time during operation. In this embodiment, the system can be simplified to avoid the use of pulleys or belts external of the expander. The dashed lines in FIG. 1 indicate that the expander is within the ORC and the compressor is within the VCC. This is the case for the other figures as well, at least when the expander and compressor are ORC and VCC systems, respectively.

The system of FIG. 3 is the same as FIG. 1. Like the system in FIG. 2, the system in FIG. 3 does not require belts or pulleys to function. Unlike the system in FIG. 2, the motor/generator is located between the expander and compressor. This arrangement can advantageously require only one shaft coming out of the expander. However, the motor/generator will be turning all the time, creating small amount of losses when no load is applied.

The motor/generator of FIG. 3 can function to provide supplemental power when needed to the compressor or, alternatively, generate and store power when supplemental power is not needed and the system is producing excess power. For example, when the ORC is producing excess power from genset waste heat or cooling is not needed, the motor/generator can function as a generator. On the other hand, if the supplied waste heat from the genset is insufficient to provide heat active cooling using the VCC, the motor can supply the additional power needed to drive the VCC to meet the cooling demand.

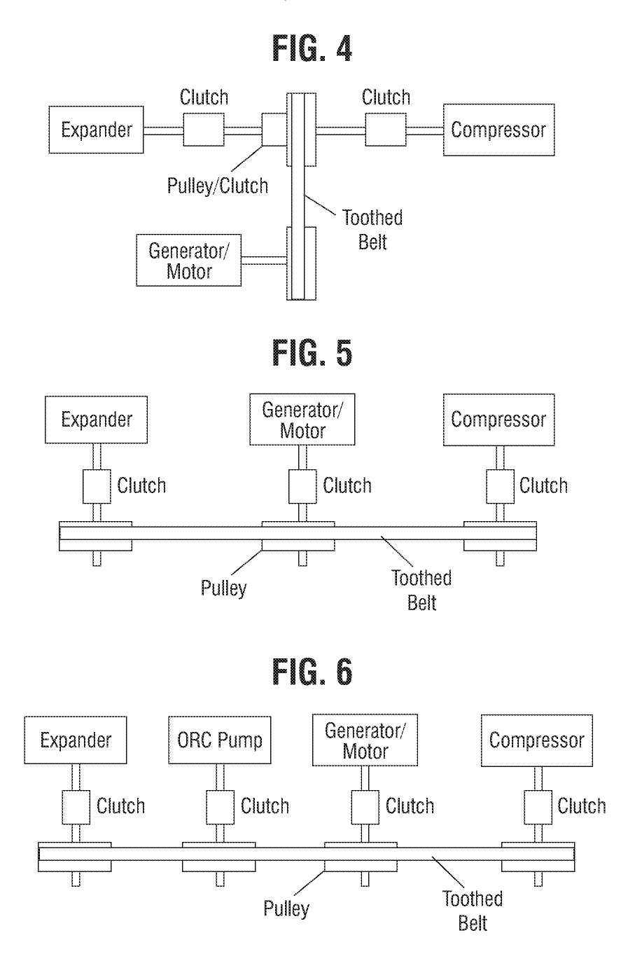

FIG. 4 illustrates another embodiment in which pulleys and a belt are added to allow the motor/generator to be disengaged from the drivetrain by operation of a clutch member positioned along the drivetrain. In addition, this arrangement can allow for easier component alignment.

FIG. 5 illustrates another embodiment in which all three components (expander, motor/generator, and compressor) are coupled through a set of pulley/clutch assemblies and a belt. In this arrangement, any of the components can be disengaged (i.e., clutched out) while the attached pulley is turning, providing greater flexibility in operation and component alignment.

FIG. 6 illustrates another embodiment in which the pump in the ORC can be connected with other moving components (e.g., motor/generator, expander, and compressor) through a clutch, pulley and belt system.

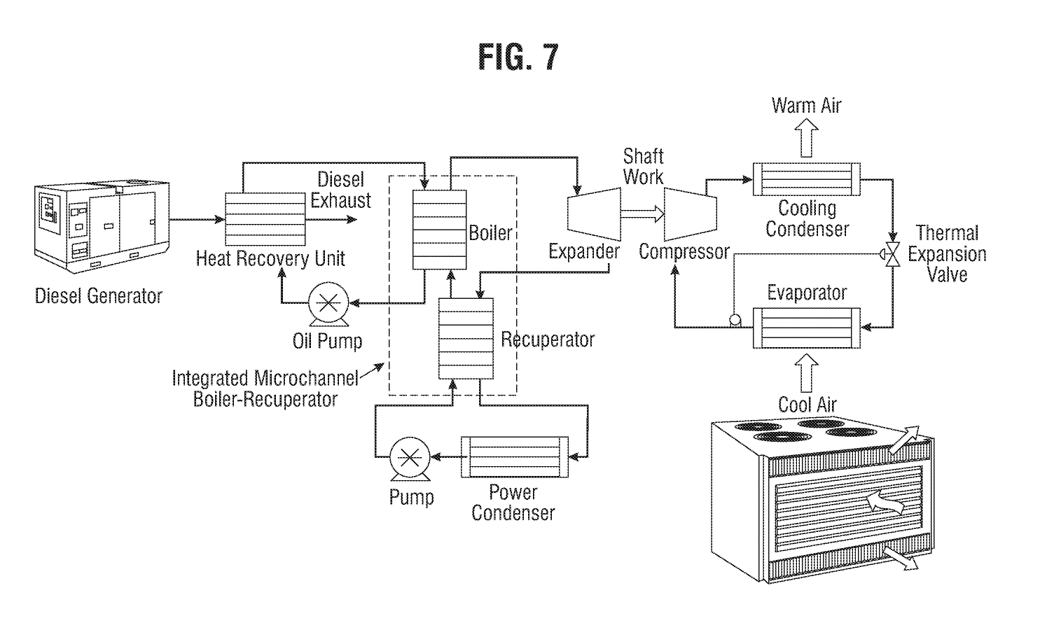

FIG. 7 illustrates another embodiment in which an innovative ORC system uses high-efficiency microchannel heat exchangers in combination with a low-cost, efficient scroll expander. The scroll expander functions like a scroll compressor operating in reverse and can be operated to generate mechanical work from the expansion of the working fluid (e.g., compressed air or gas). Scroll expanders also can have high tolerances, which leads to more efficient operation, and can be relatively stable in speed and pressure ratio, which can be desirable for partial load conditions. In the system shown in FIG. 7, mechanical power is generated from the ORC system, which directly drives the compressor (i.e., a VCC compressor) to reduce power conversion losses.

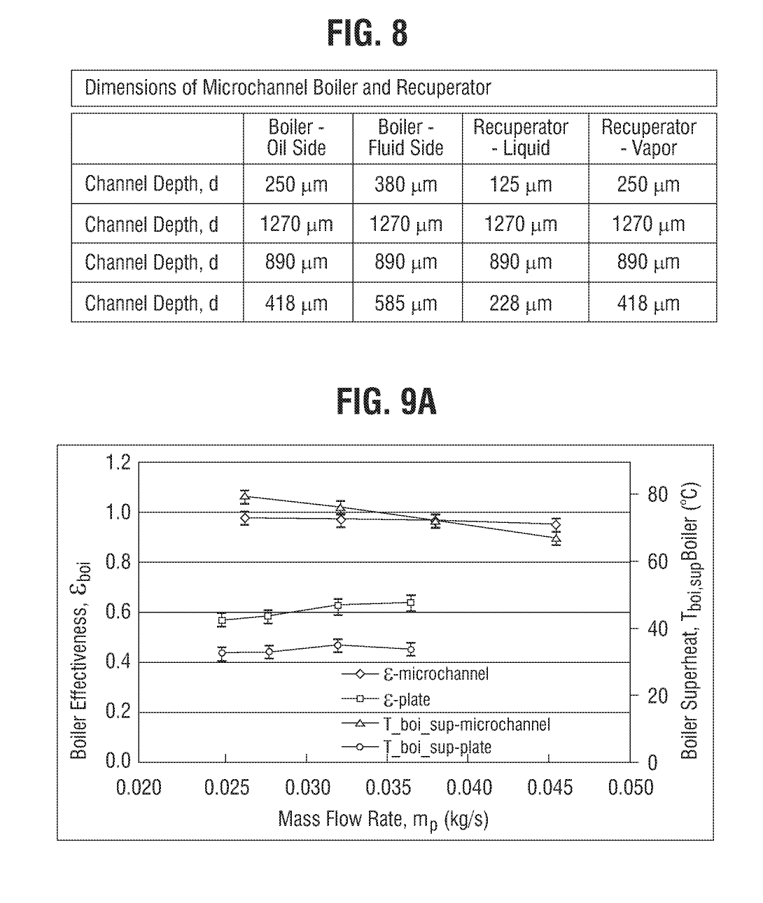

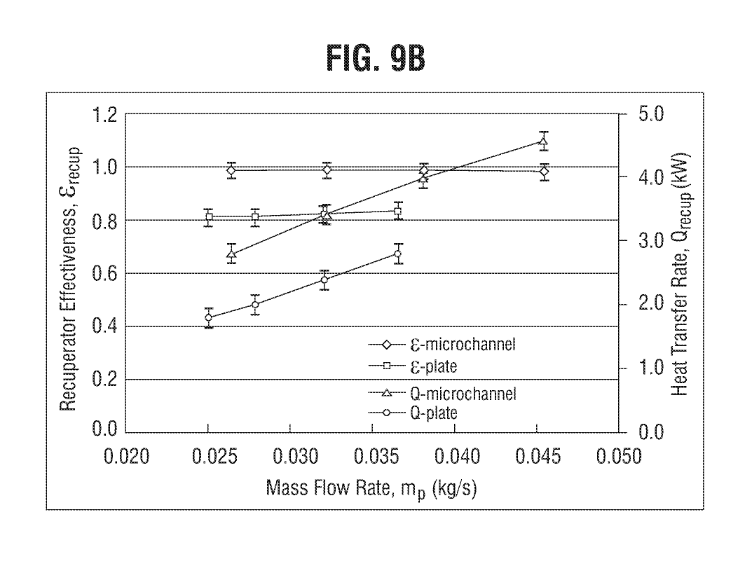

The use of microchannel heat exchangers, as shown in FIG. 7, can provide significant performance, size, and weight advantages over conventional plate heat exchangers. For example, FIG. 8 illustrates exemplary dimensions of microchannel boiler and recuperators, and FIGS. 9A and 9B illustrate comparisons between the effectiveness of microchannel heat exchangers and plate heat exchangers. In one embodiment, the exemplary dimensions indicated in FIG. 8 can vary (plus or minus) by 50% of the values shown. Thus, for example, the channel depth of microchannel boiler (oil side) can vary from 125 μm to 375 μm, and the channel width microchannel boiler (oil side) can vary from to 635 μm to 1905 μm.

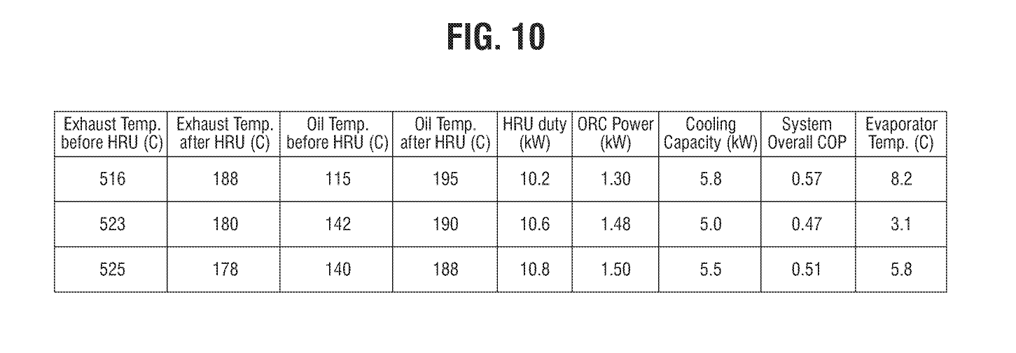

FIG. 10 illustrates exemplary testing results of the system shown in FIG. 7. In each test, a diesel generator was running at full load with −13.5 KW of electrical output power and the runtime for each of the three days tested was greater than four hours. The ambient conditions were different, with the second day being the coldest of the three. On the first testing day, Paratherm NF was used in a secondary heat transfer fluid loop, on the second and third days, Duratherm 600 was used in a secondary heat transfer fluid loop.

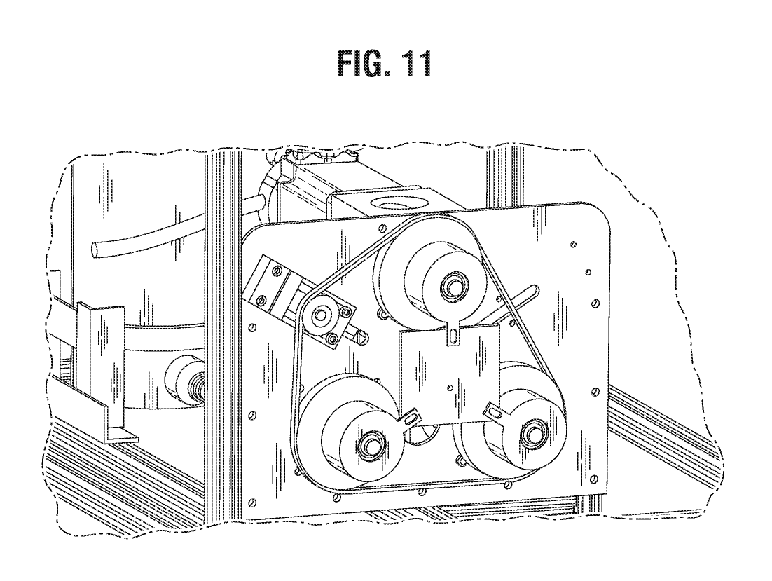

FIG. 11 illustrates an exemplary drive component system with three electromagnetic clutches, such as the three-clutched system shown in FIG. 5. Various types of clutches can be used with such systems. In one embodiment, the clutches can be, for example, Ogura AMC-40 electromagnetic clutches, which consumes about 9 watts while engaged and can transmit 4 N-m at speeds of up to 3600 RPM. Various belt systems can be used, such as, for example, GT 5 mm timing belts and pulleys. These systems can be nearly 99% efficient and can provide good torque transmission. Ball bearing supports can also be used to provide radial support with estimated efficiencies of close to 90%.

Although the primary function for the system is to produce cooling, in each embodiment disclosed herein with a motor/generator when the diesel generator produces waste heat more than needed for the ORC to drive the vapor compression cooling cycle, the motor/generator can be engaged to generate and output electric power. In contrast, when the diesel generator could not provide enough heat to run the cooling cycle, the motor/generator can pull additional power from the diesel generator to supplement cooling that is needed in those conditions. During periods when no cooling is needed but waste heat is available, all shaft power from the ORC can run the motor/generator to produce electric power output. This flexible power output and input while keeping consistent cooling capacity from diesel generator waste heat is incomparable for many other heat activated cooling technologies.

In addition, the invention can combined with current military ECUs using a motor/generator to replace the motor inside the compressor housing, achieving both power generation and consumption functions to produce cooling. The product can include, for example, an ORC power unit, a motor/generator with control and an ECU cooling unit. As a dual-cycle system, the system also can have increased flexibility in its manner of operation. As discussed above, the system can output power when cooling is not needed or output a combination of power and cooling as needed. This feature can be very useful in ECU applications, such as those used in some military operations, to not only meet cooling needs in hot seasons with improved diesel generator fuel efficiency, but to also achieve fuel savings year around.

Thus, for example, at least the following four operational modes can be achieved:
Waste heat→cooling (sufficient genset waste heat)
(Waste heat+motor power)→cooling (insufficient genset waste heat)
Waste heat→power (no cooling needed)
Waste heat→cooling+power (partial cooling needed)

The systems and methods disclosed herein can also apply to a combined cooling, heating and power (or tri-generation) system. For example, in such systems, the heat input can be waste heat or it can be generated by natural gas to produce power and/or cooling. In addition, the generator to output ORC power can be operated reversely as a motor, providing supplemental power needed to drive the cooling cycle compressor in achieving the cooling needs.

In another embodiment, a heating function can be added to the system as a desirable function for climate control. Various heating functions are possible. In one embodiment, one or more electric resistance heaters can be adapted for use in the systems disclosed herein. In a second embodiment, a heat pump cycle can provide the heating function. This requires adding a valve system to shift the evaporator and condenser around. Although this achieves a higher coefficient of performance (COP) than a resistance heaters, heat pump cycles can suffer greatly reduced heating capacity in cold climate. In addition, such systems require that the power produced in the ORC be consumed by the compressor to realize heating.

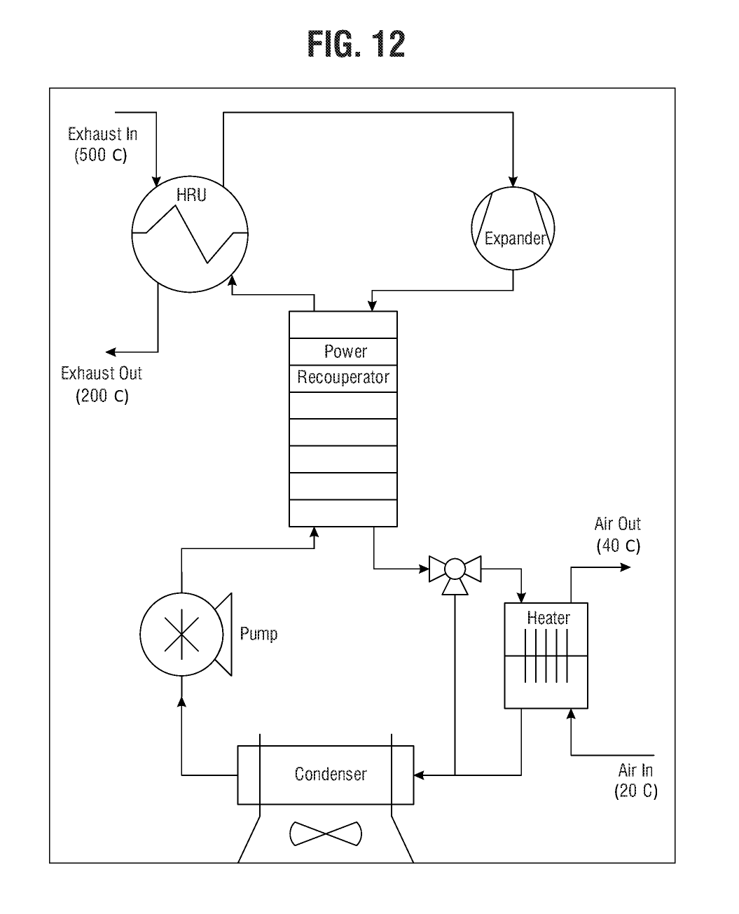

Alternatively, the heating function can be achieved using condensing heat of the power cycle (waste heat recovery system). In addition to using the condensing heat of a standard condenser of a power cycle, an embodiment of using a waste heater (secondary condenser) is shown in FIG. 12. FIG. 12 is similar to FIG. 7, in that it illustrates an ORC, which includes a heat recovery unit (HRU)—the ORC boiler, an expander, a power recouperator, a pump and two condensers. In addition to a primary (power) ORC condenser, however, the embodiment shown in FIG. 12 also includes a heater which comprises a second ORC condenser, and the heating function can be achieved solely from the power cycle waste heat (fluid condensing heat) while valuable power output from the ORC expander remains available.

As shown in FIG. 12, a 3-way valve (or two separate sets of valves) can be used to direct an expanded vapor coming from the power cycle recuperator into either the primary ORC condenser or the waste heater.

When the expanded vapor is directed to the primary condenser, the power output from the ORC can be used to drive the cooling cycle to obtain cooling. In contrast, when the expanded vapor is directed through the waste heater (i.e., the secondary condenser), the output from the ORC includes both heating and power. In this embodiment, heating can only be provided when a waste heat source is available. To mitigate this limitation, the waste heat option described in this embodiment can be combined with backup electrical resistance heating as discussed in more detail below.

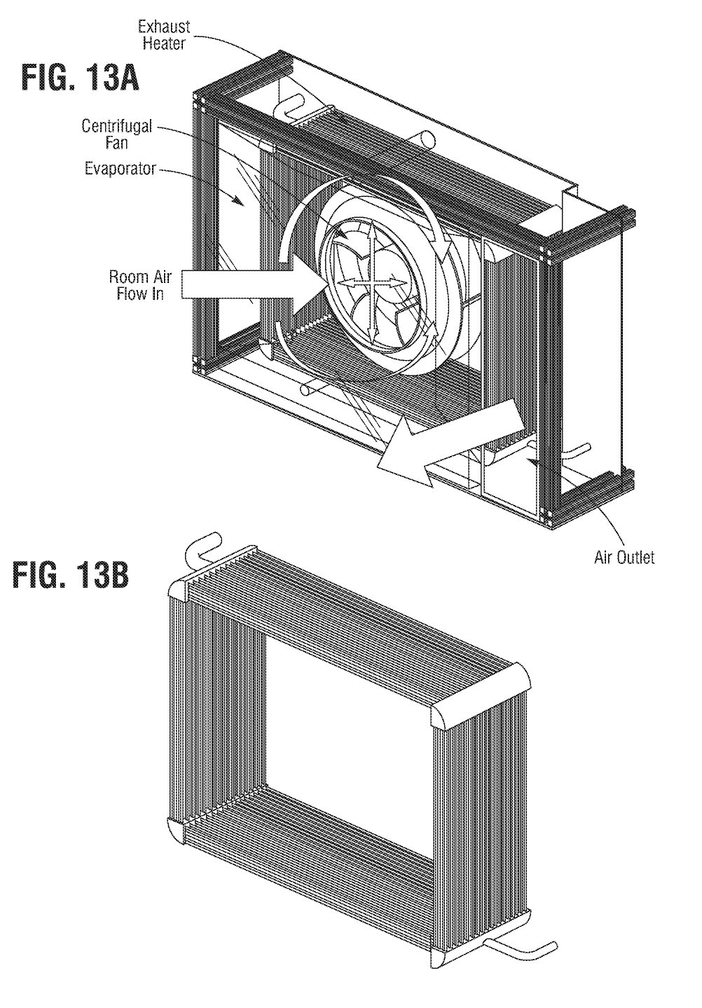

The optional waste heater system described above can be integrated into hybrid power and cooling systems, such as those disclosed herein, in various manners. For example, as shown in FIGS. 13A and 13B, a waste heater can be integrated into an evaporator section of current hybrid power and cooling system through the addition of a compact rectangular waste heater system that fits around an existing centrifugal fan. As shown in FIG. 13A, cold air is drawn through the evaporator in front of the fan, enters from the center of the fan, and is then pushed through the exhaust heater. The condensing heat from the ORC then heats the air to a desired temperature, thereby achieving the space heating function. Meanwhile, the ORC outputs “free” power through the motor/generator.

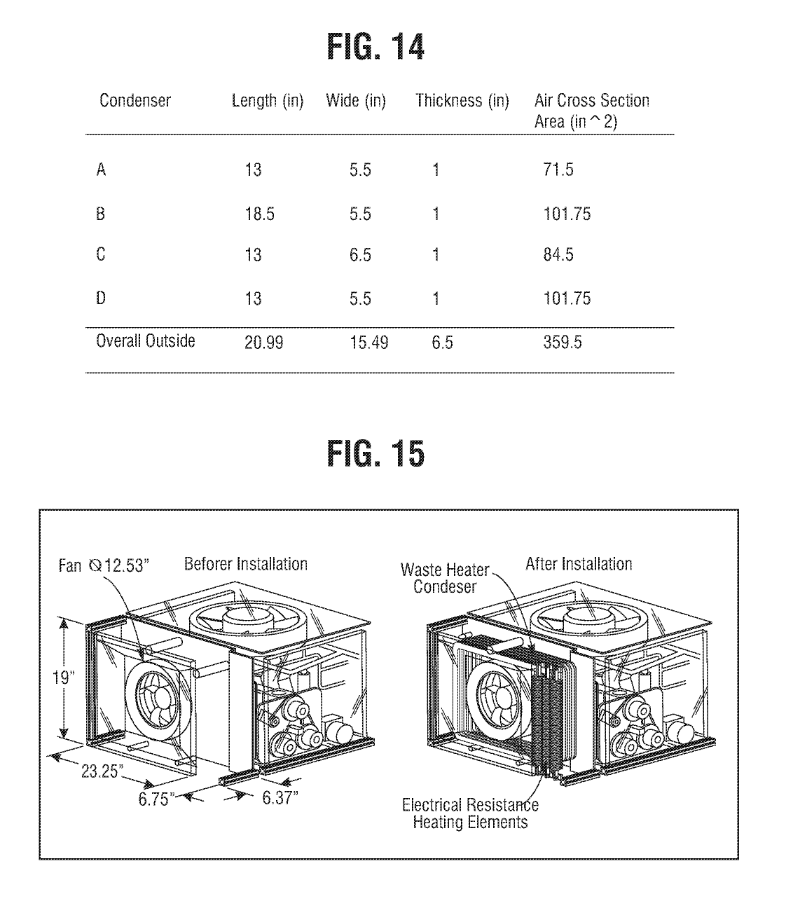

The waste heater can be made of various materials. In one embodiment, the water heater can be made of extruded aluminum tubes using controlled atmosphere brazing (CAB). FIG. 14 shows exemplary dimensions of sections of the heating panel. Of course, these dimensions can vary depending on the application. If desired, fins can be provided between the extruded tubes provide to improve air side heat transfer. Preferably, the fin density is tailored for a particular application so that the improved heat transfer does not create excessive air flow restrictions.

As discussed above, it may also be desirable to obtain heating with an environmental control unit (ECU) applications when a waste heat source is not available. To achieve this result, one or more backup electrical resistance heaters can be provided. FIG. 15 illustrates a flexible cooling, heating and power concept that includes a waste heater and backup electrical resistance heaters. One embodiment, similar to that shown in FIGS. 13A and 13B, provides for the waste heater and the electrical resistance heaters in close proximity to each other providing an integrated cooling, heating and power system for use with an ECU.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A hybrid power and cooling system comprising:
a cooling system that absorbs and removes heat from a space, the cooling system comprising a compressor for compressing a circulating refrigerant;
a waste heat recovery system with an expander configured to use a working fluid to generate mechanical work by expansion using heat received from a heat source, the waste heat recovery system being coupled to the compressor of the cooling system to drive the compressor by the generated mechanical work; and
a motor/generator coupled to the compressor of the cooling system to drive the compressor.

2. The system of claim 1, when the expander is within an organic Rankine cycle and the cooling system is a vapor compression cycle.

3. The system of claim 1, wherein the motor/generator is coupled to the expander and can receive the mechanical work from the expander and convert it to electrical energy.

4. The system of claim 3, further comprising at least one clutch member that allows disengagement of the motor/generator from the system.

5. The system of claim 1, further comprising a plurality of clutch members for independently engaging or disengaging each of the compressor, expander, and motor/generator.

6. The system of claim 2, further comprising a space heating system, the space heating system comprising a primary condenser and a secondary condenser, and at least one valve that can be moved between a first position in which an expanded vapor is directed from a power recouperator of the waste heat recovery system to the primary condenser and a second position in which the expanded vapor is directed from the power recouperator to the secondary condenser to provide space heating.

7. The system of claim 6, wherein the space heating system further comprises at least one electric resistance heater.

8. The system of claim 6, wherein the at least one valve comprises a 3-way valve.

9. A hybrid power and cooling system comprising:
a cooling system comprising a vapor compression cycle having a shaft-driven compressor;
an expander within an organic Rankine cycle coupled to one or more waste heat sources for generating power to drive the shaft-driven compressor; and
a motor/generator coupled to the cooling system to drive the shaft-driven compressor when the power generated by the expander is insufficient.

10. The system of claim 9, wherein the motor/generator is also coupled to the expander to convert power generated by the expander into electrical energy.

11. The system of claim 10, wherein the motor/generator and cooling system collectively comprise an environmental control unit (ECU).

12. The system of claim 9, further comprising one or more clutch members that allow each of the expander and motor/generator to engage the shaft-driven compressor separately or collectively.

13. A method of recovering waste heat to drive a hybrid power and cooling system, the method comprising:
directing primary waste heat to an organic Rankine cycle system with an expander that is configured to use a working fluid to generate power by expansion;
driving a compressor of a cooling system that is configured to absorb and remove heat from a space using the power generated by the expander; and
supplementing the power generated by the expander with mechanical work produced by a motor/generator coupled to the compressor of the cooling system to drive the compressor.

14. The method of claim 13, further comprising:
disengaging the motor/generator from the system when the power generated by the expander is sufficient to meet a current cooling demand.

15. The method of claim 13, further comprising:
using the motor/generator to convert power generated by the expander into electrical energy when no cooling is needed or the power generated by the expander exceeds that needed to meet a current cooling demand.

16. The method of claim 13, wherein the primary waste heat source comprises heat generated by a remote power supply.

17. The method of claim 13, further comprising:
providing at least one valve moveable between a first position in which an expanded vapor is directed from a power recouperator of the waste heat recovery system to a primary condenser and a second position in which the expanded vapor is directed from the power recouperator to a secondary condenser to provide space heating; and
moving the valve from the first position to the second position to provide space heating.

18. The method of claim 17, wherein the at least one valve comprises a three-way valve.
